(19) United States
(12) Patent Application Publication
(10) Pub. No.: US 2006/0055130 A1
(43) Pub. Date: Mar. 16, 2006

(54) Utility sleigh

(76) Inventor: Haywood Williams JR., Plano, TX (US)

Correspondence Address: Haywood Williams, Jr., 701 Wedgegate Dr, Plano, TX, 75023, US

(21) Appl. No.: 10/939,224

(22) Filed: Sep. 10, 2004

(51) Int. Cl. B62B 13/00

(52) U.S. Cl. 280/24

(57) ABSTRACT

A device for tractor or AtV Hauling of materials and debris. Designed like a flat bed or mat with sleigh type characterists. A flat Bed all terrain hauler. No trailer wheels required. This flat bed sleigh is designed in three types; (1.) it will be moulded out of plastic or metal, (2.) have a half-post flat sheet, (3.) or Oval Saucer designed in a short-sleigh type construction, made to haul almost anything. Hunters or campers have an inexpensive and convient way to haul materials or game. If the ATV or hauling vehicle can move over the surface, then the flatbed will have the same mobility. It will be made in various sizes and designs. In the front the sleigh will have an assembly used for a chain or V-hitch apparatus to attach to the hauler. Also a Patented V-Hitch assembly will allow the load to be towed with stability.

### BRIEF DESCRIPTION

A device made for a tractor or atv used to haul or tow materials and debris. Designed like a flat bed or mat with sleigh type characterists.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of hauling, towing, sporting goods, lawn and gardening and more specifically to ATV accessories. A good hauler would be an ATV, Golf Cart, or Lawn tractor. It will make hauling large wild game, materials, debris, trash, etc., with easy use of the sleigh type design.

As a young man that grew up in a country town. My parents and Grandparents lived on the same Acreage and shared many utilities of tending to the land as well as building on the land. At the age of 10, in 1983, my father bought a 3-wheeler ATV Motorcycle. I was to use this ATV as an utility device for work and for fun. In the utility side of owning the ATV we cut a lot of fire wood, and threw away a lot of old wood and debris collected over the years. Needless to say, my role was to make sure I hauled everything away; tasked to me and my ATV.

The problems began with the way I had to hauled things on the ATV. There was a rack on the back of behind the seat. The rack was only 3 feet wide by 2 feet long and directly attached to the rear of ATV. Because of the closeness of the load placement, I used to get scratched and cut with the piles I loaded on this rack. The loads also shifted and fell off at times. Needless to say, I found one of my grandpa utility chains he used to pull trees down, and began tieing the loads in bundles with rope and hauling it accross the yard. This was great because I was not being injured anymore from the debris directly behind me scratching and cutting me as the loads shifted. But I still had a problem, some of the debris was falling out and off of the tied down bundles and some Items I had to pull alone across the yard. The good thing was that this increased my load capacity and decreased the runs. The bad thing was that pointed objects cut the lawn up as I hauled tables, stoves, tree limbs, concreted pipe, etc.

One day as I cleaned a certain area of my Grandpa's collected wood pile, I ran across a thick piece of Tin Metal. This metal was about 9 feet long and 5 feet wide. It weighed about 75 pounds. I pulled it out and visioned loading up lots more debris and items haul it off and be finished my work in no time. I took a pick axe, bored a hole at the front middle of the sheet, got that chain, made a secure latch around the hole in the tin about 6 inches from the front middle of the tin, and attached the other end of the chain to the rack of the ATV. I pulled the empty tin around the yard a few times, and saw that If I maintained a moderately slow speed I could control the tin's direction of pull. I immediately loaded the peice of tin with about 300 pounds or more of debris and took it to the dumping ground of our street. Needless to say I was finished in no time and did not have to suffer to do it. Basically, I slid all of the debris off of the tin, easily, with a few good pulls. My Father and Grandfather called me lazy, but clever.

There was really no prior technology for this type of device. Only trailer and wagons, all bulky, having wheels and very costly. The rack on back of the ATV was about the most inexpensive device to have because the cost of it was thrown into the price of the ATV. Today, I still do not see anyone hauling their materials on a flat bed sliding sheet without wheels.

Older Technologies are:

1. Too expensive.
2. Easier to break, fix, and maintain.
3. Wheels would get stuck in wet ground.
4. Wheels would carve grooves in the ground.
5. Wheels causes the load to bounce and top heavy loads fall.
6. Limited loads can be carried at a time depending on the cost and size of the wagon.
7. ATV racks keep the load too close to the operator which can be hazardous or troublesome.

### BRIEF SUMMARY OF THE INVENTION

The Primary Object of the Invention has 3 Basic Designs:
1. Moulded flatbed in short sleigh design.
2. Oval Saucer Design
3. Half-Post Flat sheet
   Another object of the invention is Ideal for hunters pulling game and supplies with their ATVs.
   Ruff and rugged design to hold all materials and slide across any surface.
   Another object of the invention is the tow bar V-Hitch Assembly. This will be a V designed Hitch with attaches to any standard ATV Hitch at the point of the V
   and each leg of the V will attach to the front of the Utility Sleigh on the right and left side bolts.
   The V-Hitch will provide a stable and uniform load and tow.
   To hitch the Utility Sleigh to the Hauler can be done in two ways; (1.) The V-Hitch Assembly (2.) The Chain pull assembly. This will be a chain attached to the middle rod of the sleigh or attach both sides of a chain on both end corner rings, then attach a chain to pull at the center of the chain. This V-hitch is designed in a standard or adjustable design.
      Moulded Flatbed in Short Sleigh Design
   Another object of the invention is On the two front corners there will be a ring mould that will be able to pull loads by a 3 point chain latch system.
   On the front center of the Utility Sleigh, there will be a heavy duty handle that will allow the operator to attach a straight chain to the Utility Sleigh from a Center point of the ATV/Hauler.
   The Utility Sleigh will come in various sizes. They start at 3 ft-8 ft wide and 5 ft and up in length, maybe 3 in in depth.
   The durability of the material comprising the sleigh will ensure the strength of the sleigh.
   The Utility Sleigh will allow the user to strap down the load and pull it across all types of terrain, hills, ditches, cuts, and shrubery.
   The Mould can be in a Pontoon Railer Design, where the mould would be an imitation imitation of a pontoon boat.
      Oval Saucer Design
   Allow's for glide over any surface.
   Countour sides also keep-liquid waste from spilling.
   Countour sides allow for easy loading and towing for very heavy items such as large wild game.
   Front will have a steel rod inserted from the side for attachment of V-hitch Assembly.
      Half-Post and Flat Sheet Design
   Half Post will be a 4-6 inch post split half radius log.
   Half Post length will be the width of the flat sheet or smaller.
   This is the least expensive design.
   A Steel handle will be bolted to the top center of the post and there will be a steel plate under the flat sheet where the half post attaches to the sheet providing a secure latch assembly for the front of the sleigh.
   On the sides of the post will be studs made to attach to the legs of the V-hitch Assembly with cotter pins.
      V-Hitch Assembly

The V-Hitch Assembly is another invention-claim that will work with the Utility Sleigh. The V-Hitch assembly will provide the owner a stable pull or tow by making the load shiftless and uniform with the hauler or ATV.
Standard ATV hitch Assembly at the point of the V-Hitch.
V shaped square iron welded material engineered to displace the center of gravity of the hauler and attaches to the sleigh at a leveling angle for towing.
Keeps sleigh, load, and hauler in one motion or as a unidirectional load with the ATV/Hauler.
Each leg of the V will have a hole designed for attachment to the side stud or rod of the sleigh where the stud or rod will have a small hole to insert a cotter-pin to secure the V leg to the side studs of the sleigh for secure attachment.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, this is a disclosed machine for a tractor or ATV for Hauling or Towing materials and debris across any ground surface. Designed like a flat bed or mat with sleigh type characterists.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

Table of Figures.

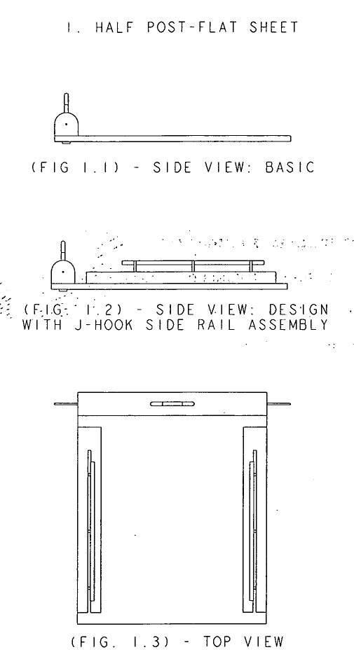

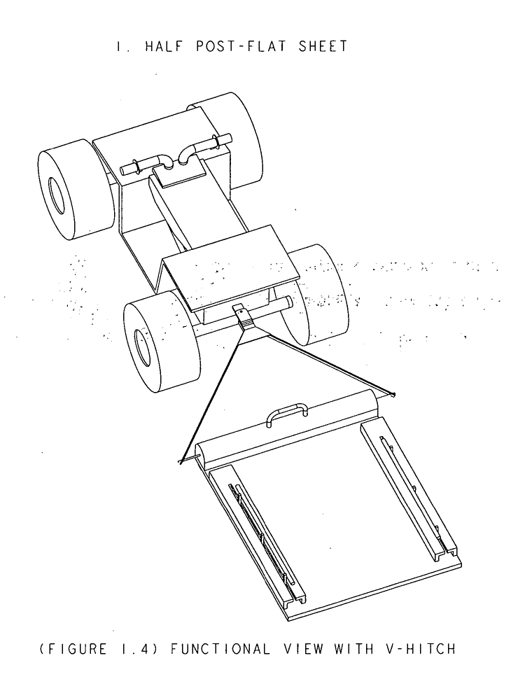

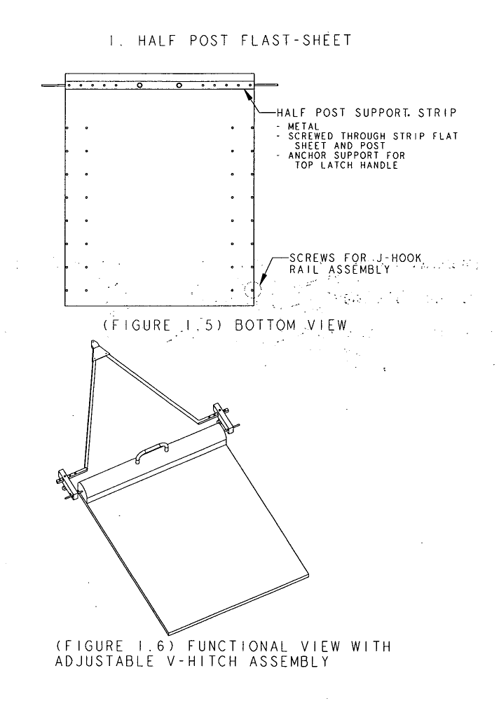

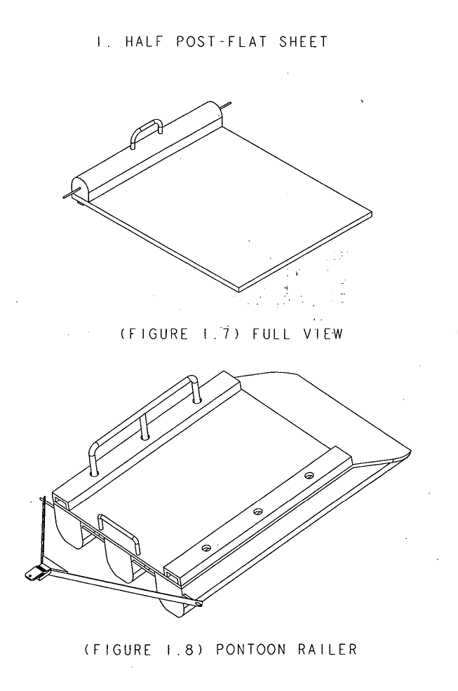

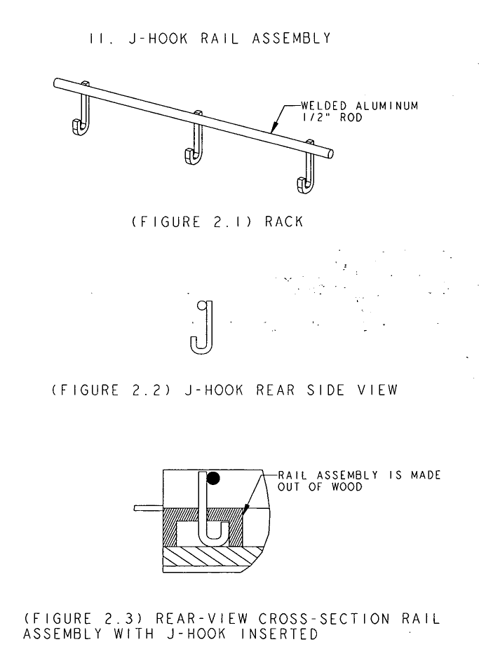

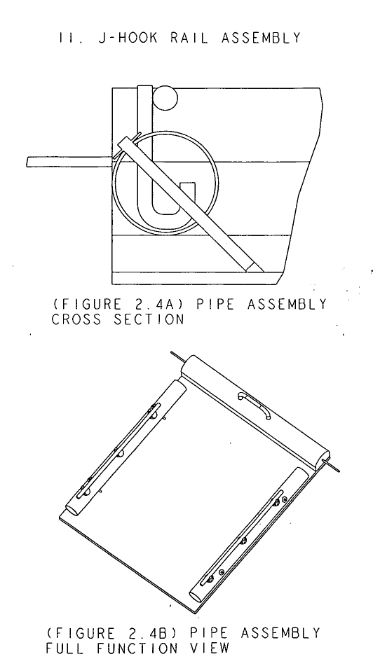

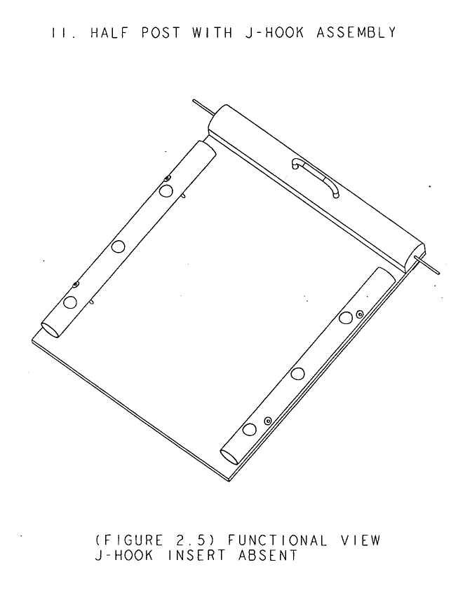

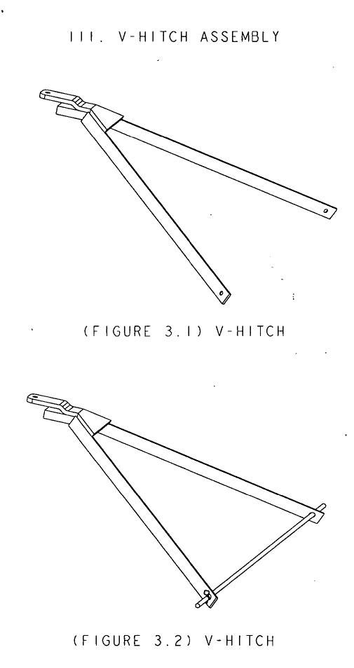

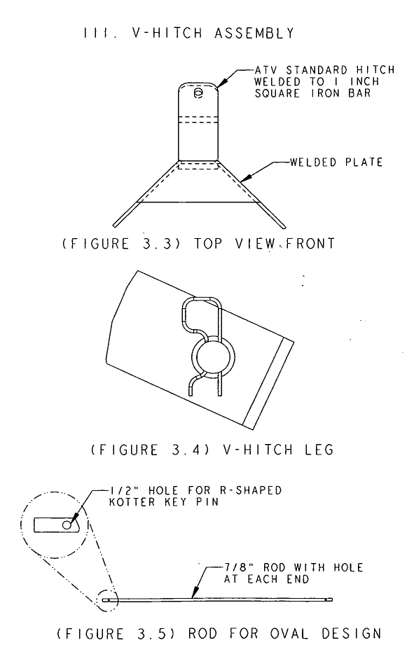

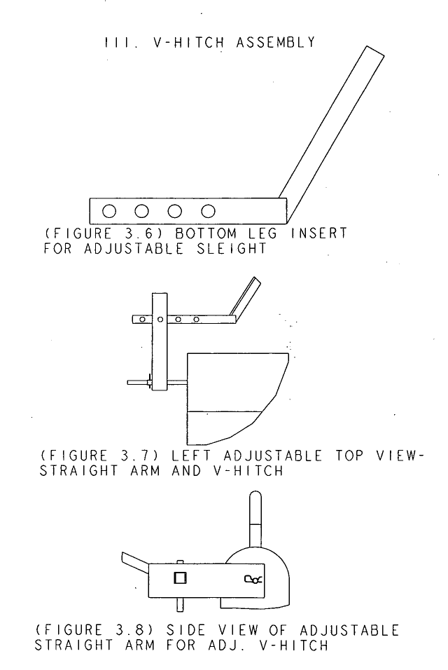

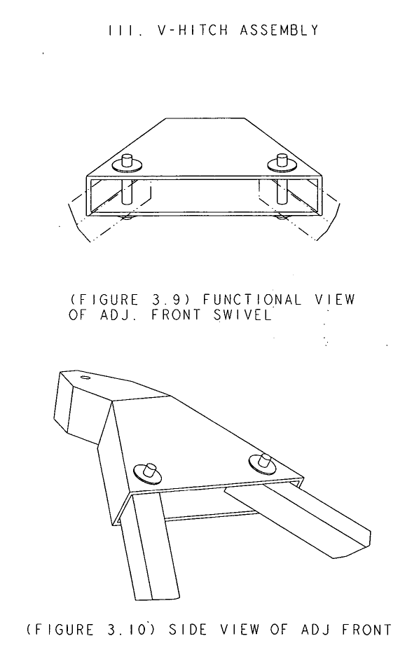

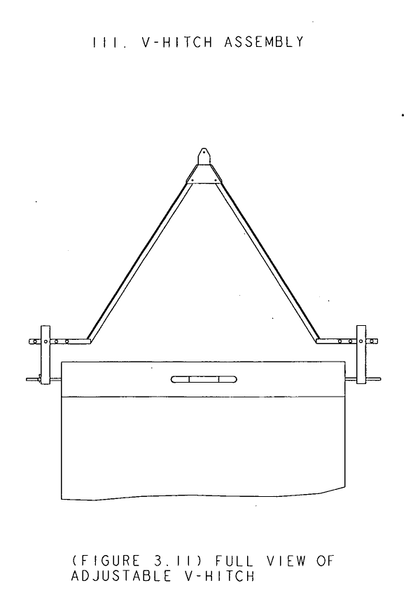

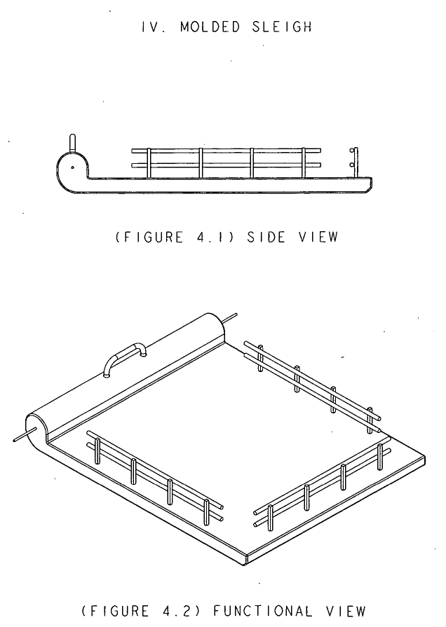

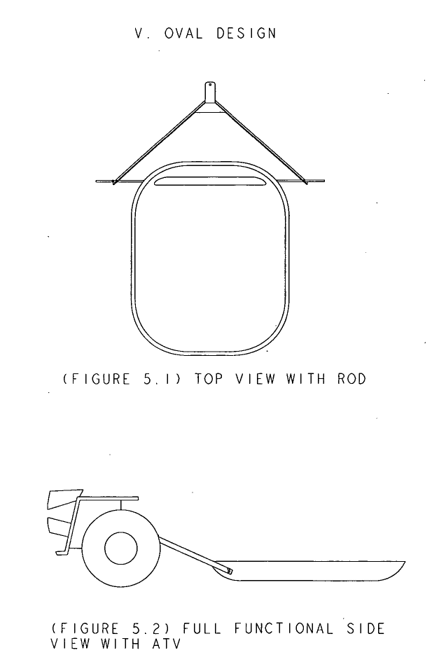

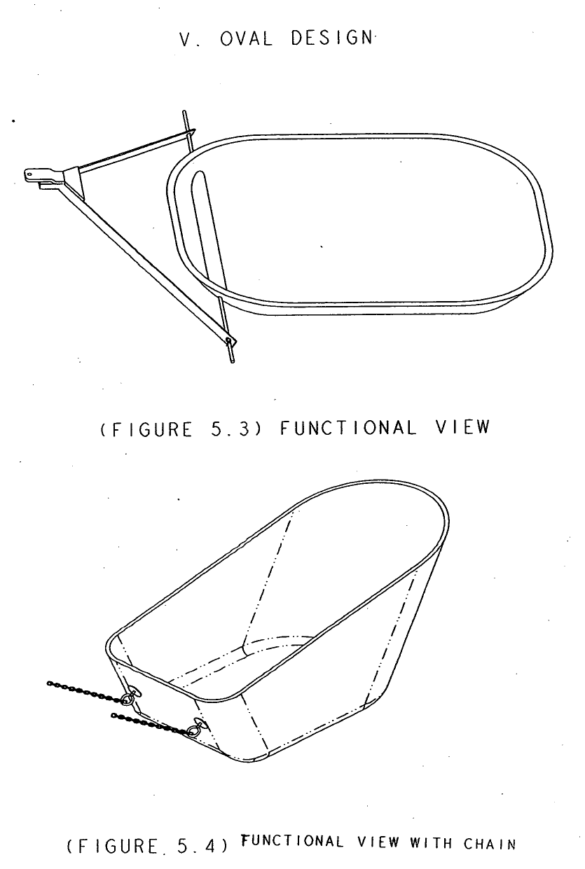

The following pages will show drawings of the 3 different designs of the sleigh as well as the Rail and Hitch Assemblies.

| I. Half Post-Flat Sheet Utility Sleigh | | |
|---|---|---|
| FIG. 1.1 | Side view | pg. 11 |
| FIG. 1.2 | Side View with Rail Assembly | pg. 11 |
| FIG. 1.3 | Top View | pg. 11 |
| FIG. 1.4 | Functional View with V-Hitch | pg. 12 |
| FIG. 1.5 | Bottom View | pg. 13 |
| FIG. 1.6 | Functional View with Adjustable V-Hitch | pg. 13 |
| FIG. 1.7 | Full View | pg. 14 |
| FIG. 1.8 | Pontoon Railer | pg. 14 |
| II. J-Hook Rail Assembly | | |
| FIG. 2.1 | Rack | pg. 15 |
| FIG. 2.2 | J-Hook Rear Side View | pg. 15 |
| FIG. 2.3 | Rear View w/ J-Hook Assembled | pg. 15 |
| FIG. 2.4a | Pipe Assembly-Cross Section | pg. 16 |
| FIG. 2.4b | Pipe Assemly-Full View | pg. 16 |
| FIG. 2.5 | Sleigh View w/ Standard Asmbly. no rail | pg. 17 |
| III. V-Hitch Assembly | | |
| FIG. 3.1 | Full View V-Hitch | pg. 18 |
| FIG. 3.2 | Full View V-Hitch w/rod | pg. 18 |
| FIG. 3.3 | Top View Front | pg. 19 |
| FIG. 3.4 | Side View Bottom | pg. 19 |
| FIG. 3.5 | Rod for Oval Design | pg. 19 |
| FIG. 3.6 | Bottom Leg Insert for adjustable sleigh | pg. 20 |
| FIG. 3.7 | Left Adjustable Top View | pg. 20 |
| | Straight Arm and V-Hitch | |
| FIG. 3.8 | Side View of Adjustable Straight Arm | pg. 20 |
| | For Adj. V-Hitch | |
| FIG. 3.9 | Functional View of Adj. Front Swivel | pg. 21 |
| FIG. 3.10 | Side View of Adj. front | pg. 21 |
| FIG. 3.11 | Full View of Adjustable V-Hitch | pg. 22 |
| IV. Moulded Sleigh Design | | |
| FIG. 4.1 | Side view | pg. 23 |
| FIG. 4.2 | Functional View | pg. 23 |
| V. Oval Design | | |
| FIG. 5.1 | Side View with Rod | pg. 24 |
| FIG. 5.2 | Full Functional Side View with ATV | pg. 24 |
| FIG. 5.3 | Functional View | pg. 25 |
| FIG. 5.4 | Functional View with chain | pg. 25 |

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

Utility Sleigh

Three Basic Designs

1. Half. Post-Flat sheet
2. Oval Saucer
3. Moulded metal or Plastic Sleigh
   Assembly Device.

To attach the sleigh to the Hauler, the sleigh will be attached via the V-hitch assembly. For the V-hitch Assembly to work, the sleigh must have a steel rod that will go through top front of the Half Post or Oval Saucer's width and pertrude each side for attachment to the V-hitch as Side Studs for kotter-pin assembly on the Half-Post design or Oval Saucer. The V-Hitch will be a standard ATV hitch latch assembly for attachment to the ATV/hauler. This standard ATV hitch will be welded to square-iron pipes forming a V-shape where the end of the legs of the V will have holes for the securing the sleigh with the kotter-pin.

To further the design of the V-Hitch Assembly, the V-Legs can be made in an adjustable form. The Adjustable V-Hitch Assembly will have the V-Legs (designed at a different angle) where each end of the V legs will end at 3 inches in front of the sleigh, then make a parallel outward angle with the Front of the sleigh. On these parallel extensions of the V-legs of the V-Hitch, there will be holes through the top and bottom of the V-leg extentions which will align with the Sleigh's side post pegs for a slide bar assembly that attaches the V-leg extensions to the utility sleigh.

The Utility Sleigh has another design for the side rails this can be assembled by an aluminun gate device with special j-hook legs that will latch to the flat bed's side rail assembly. This side rail assembly will have two flat 1×2 inch square wood pieces the length of the sleigh. These two square wood pieces will be separated by 1-½ inch gap. There will be a 1×5 inch wide flat plank to go across the two square wood pieces that will have reinforced holes to align with the j-hooks of the rail. The j-hook rail will simply hook into the holes of the side rail assembly and will require rope to tie down both sides of the rails to the load.
Inventions already known all have wheels in their design. They are bulky and not traversable across all terrain.
Regular sleighs are made for snow and ice. This invention is simply a flatbed designed to slide across most terrains.
This is a new way to haul loads with you lawn tractor, Golf Cart, and/or ATV. It will simply attach to the hauling vehicle on it's rack or hitch assembly.
Since this Flatbed sleigh ATV hauler has no wheels, it will slide across most surfaces without causing major damage to the ground, grass and vegatation.
Allows for easy loading of very heavy materials.
Allows an ideal use for hunters to haul their game out of the woods without much lifting and no damage to the game.
This device will be pulled across most any terrain as long as the tractor and ATV can pass across the surface.
Simply a flat sheet of metal or plastic can perform the job if the front of the sheet is countoured in an upward direction to eliminate the sheet from burying itself in the ground upon movement. If built strong enough, it can be used as an atv ramp for loading the ATV in the bed of the truck. The moulded sleigh design can also be able to float across some water and mud surfaces because of the styrofoam filled body of the hollowed plastic sleigh.
This device is simply a flatbed that will slide on the ground to haul virtually anything that the operating device can tow.
This device will allow land owners and big game hunters to haul any and all materials, debris, garbage, and taken game with the use of their ATV or tractor/hauler.
The sleigh can be engineered to be hinged to provide a folding apparatus for compact storage.
Hauling devices: 4 wheelers, other types of ATVs, Golf Carts, lawn tractors, tractors, snow mobiles.
Ground Surfaces and Terrain: small ditches, tall grass, trails, muddy paths, asphault, concrete, farm land, wood lands, praries, plains.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. UTILITY SLEIGH: A machine for a tractor or atv Hauling or Towing sleigh type characterists.
a. A flat Bed all terrain hauler
b. Pull objects and materials with your tractor and ATV/hauler without wheels;
c. A V-Hitch Assembly that will connect the ATV to the Utility Sleigh. The V-Hitch will have a standard design and an adjustable design. It will be used to keep the sliegh in a uniform directional motion with the ATV.
d. A Side Rail that uniquely hooks into the side rail assembly of the sleigh.
e. A way to haul large wild game from the camp or stand back to the vehicle.

2. If the ATV or any other vehicle can move over the surface, then the flat
a. Inexpesive design;
b. Able to be made in various sizes and designs:
c. Design types:
1. Moulded Sleigh
2. Half-Post Flat Sheet
3. Oval Saucer

3. In the front there is an opening that is used for a chain or Patented V-Hitch assembly;
a. The latch is made of a steel rod strong enough to hold a ton of weight;
b. Most Designs resembles a bowl/dish form for liquid waste;
c. Steel rods/rack that can be inserted in the sides and back to hold
d. V-Hitch Assembly:
1. Provides stable towing for hauling.
2. Adjustable to any sized sleigh.
3. Hauler and sleigh will move in one direction.
e. Chain or rope towing allows the sleigh to shift weight during the travel.
f. Standard Hitch Assembly designed at the point of the v welded into side studs of the sleigh.
